(19) United States
(12) Patent Application Publication
(10) Pub. No.: US 2002/0073585 A1
(43) Pub. Date: Jun. 20, 2002

(54) Rising bubble display device and audio effects

(75) Inventor: Kenneth Burnett, Lincolnwood, IL (US)

Correspondence Address: Brinks Hofer Gilson & Lione, P.O. Box 10395, Chicago, IL, 60610, US

(73) Assignee: Midwest Tropical

(21) Appl. No.: 10/077,722

(22) Filed: Feb. 15, 2002

Related U.S. Application Data
(60) Provisional application No. 60/281,291, filed on Apr. 4, 2001.

(51) Int. Cl. G09F 19/00; G09F 27/00

(52) U.S. Cl. 40/406; 40/455; 40/906

(57) ABSTRACT

A rising bubble display. A pump is fluidly connected to a liquid-filled reservoir and an audio signal input is provided. A controller is coupled to the audio signal input and coupled to the pump. Upon reception of an audio signal, the controller generates a signal capable of actuating the pump.

### CLAIM FOR PRIORITY

The present application claims priority to U.S. Provisional Application No. 60/281,291, filed Mar. 4, 2001, entitled “Rising Bubble Display Device and Audio Effects,” and the entire disclosure of U.S. Provisional Application No. 60/281,291 is herein incorporated by reference.

### CROSS REFERENCE TO RELATED APPLICATIONS AND PATENTS

The following U.S. patents or U.S. patent applications relate to and further describe other aspects of the preferred embodiments disclosed in this application and are incorporated by reference in their entirety.

U.S. application Ser. No. 887,171, “Rising Bubble Display Device,” Attorney Reference No. 3266/8, filed on May 21, 1992, and is now U.S. Pat. No. 5,349,771.

U.S. application Ser. No. 787,970, “Table with Rising Bubble Display,” Attorney Reference No. 3266/18, filed on Jan. 23, 1997, and is now U.S. Pat. No. 5,738,018.

U.S. application Ser. No. 73,030, “Storage Rack,” Attorney Reference No. 3266/19, filed on Jun. 27, 1997, and is now U.S. Pat. No. Des. 396,985.

U.S. application Ser. No. 880,329, “Illuminated Rising Bubble Display,” Attorney Reference No. 3266/7, filed on May 6, 1992, and is now U.S. Pat. No. Des. 348,535.

U.S. application Ser. No. 54,551, “Palm-Tree-Like Rising Bubble Display Device,” Attorney Reference No. 3266/12, filed on May 16, 1996, and is now U.S. Pat. No. Des. 390,157.

U.S. application Ser. No. 81,620, “Palm-Tree-Like Rising Bubble Display Device,” Attorney Reference No. 3266/20, filed on Jan. 7, 1998, and is now U.S. Pat. No. Des. 401,886.

U.S. application Ser. No. 82,987, “Rising Bubble Display Device,” Attorney Reference No. 3266/21, filed on Feb. 3, 1998, and is now U.S. Pat. No. Des. 403,266.

### FIELD OF THE INVENTION

The invention relates generally to the field of rising bubble displays. In particular, the present invention relates to a rising bubble display with acoustics.

### DESCRIPTION OF THE RELATED ART

Rising bubble display devices provide a soothing display of rising bubbles in water. These devices transfer air into a reservoir through a pump to create a bubbling display. The pump continuously generates a stream of bubbles rather than creating a specific pattern. It is desirable to improve these displays in a manner such that specific patterns of bubbles can be generated. The presently preferred embodiments are directed to an improved bubble display device capable of providing audio effects and synchronizing bubbling patterns to the audio effects.

### BRIEF DESCRIPTION OF SEVERAL VIEWS OF THE DRAWINGS

FIG. 1 is a block diagram showing a preferred embodiment;

FIG. 2 is a block diagram showing an alternative preferred embodiment;

FIG. 3 is a block diagram showing an alternative preferred embodiment;

FIG. 4 is a perspective view of the preferred embodiment of FIG. 1 having a panel shaped reservoir;

FIG. 5 is a side elevational view of the preferred embodiment of FIG. 1;

FIG. 6 is a sectional view taken along line 6-6 of FIG. 5;

FIG. 7 is a perspective view of an alternative preferred embodiment having a cylindrical reservoir;

FIG. 8 is a perspective view of an alternative preferred embodiment incorporating a preferred storage rack; and

FIG. 9 is a perspective view of an alternative preferred embodiment utilizing cylindrical reservoirs coupled to a table.

### DETAILED DESCRIPTION OF THE PREFERRED EMBODIMENTS

The presently preferred embodiments integrate acoustics into bubble displays having many shapes and sizes. The preferred embodiments control the release of bubbles into a liquid. Audio signals are generated and transmitted from an outside or an internal source. The release of bubbles is synchronized to these audio signals.

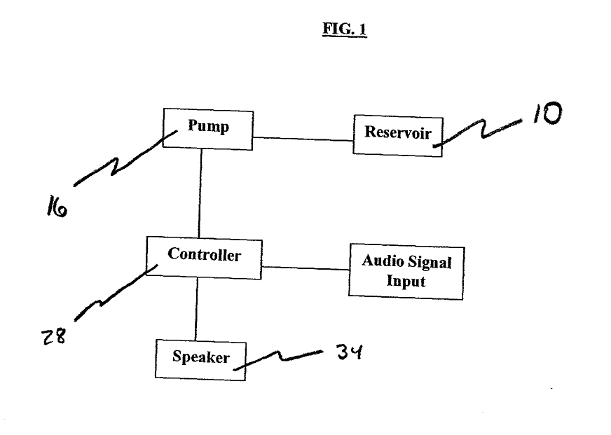

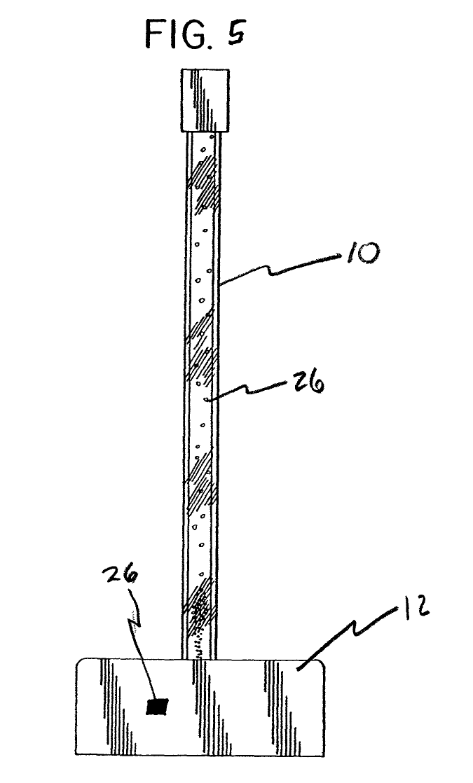

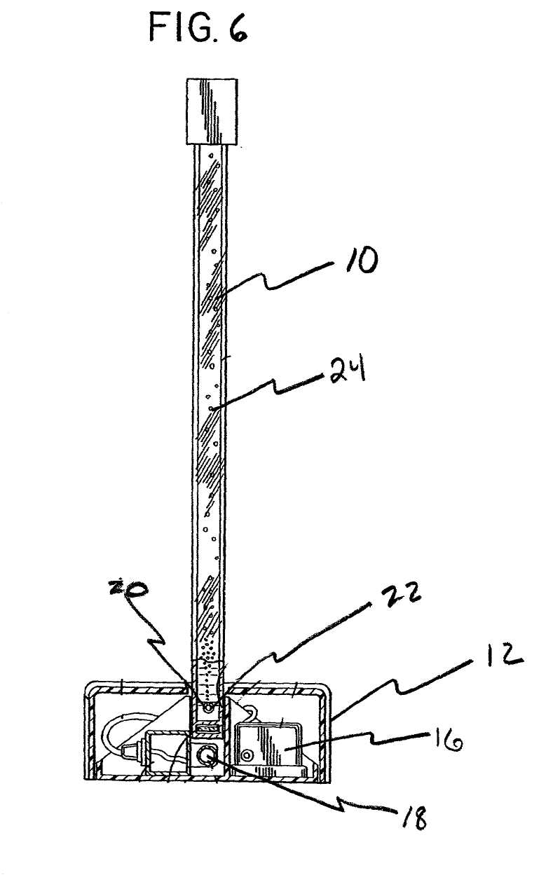

FIGS. 1 and 4-6 illustrate a presently preferred embodiment. The device includes a fluid-filled reservoir 10 that is preferably watertight. The reservoir 10 is preferably attached to a base 12, which is illustrated as a rectangular base 12, but can be sized and shaped to match the size and shape of any reservoir.

The base 12 preferably has an opening 14 which receives an end of the reservoir 10. This arrangement allows easy removal of the reservoir 10 from the base 12 for cleaning and maintenance. The base 12 also preferably includes an illumination source such as an LED, an incandescent, halogen or fluorescent lamp 16, and a device that transfers fluid such as an air pump 18 positioned so it is in fluid communication with the reservoir 10. An AC or DC power source may be provided to supply electric current to the lamp 16 and the pump 18. Alternatively, the power source can be a battery.

When actuated, the pump 16 pumps air via a conduit 20 into the end of the reservoir 10. The conduit 20 includes a check valve 22 that preferably prevents fluid from flowing into the pump 16 from the reservoir 10. A releasable coupling such as a vacuum hose coupling is provided between the check valve 22 and the pump 16. When air is released from the pump 16 into the reservoir 10, a stream of bubbles 24 rises toward the top of the reservoir 10.

A preferred embodiment also includes an audio signal input, shown in the figures as an audio port 26 into which a plug connects to an audio board. The audio port 26 can be any size, and preferably contains electrical connectors that can interface any audio device that can be plugged into the audio port 26. This type of connection allows a user to easily swap different types of audio devices that provide the audio signals to the bubble display device. Preferred audio devices include, but are not limited to, CD players, minidisk players, cassette decks, stereo receivers, MP3 players, WAV, MIDI or other electronic files directly from a computer, record players, external microphones, audio amplifiers with speakers, surround sound devices or other audio detectors.

Preferably, the audio signal input is coupled to a controller 28 capable of generating a first signal that actuates the pump 16. Upon actuation, the pump 16 releases air into the reservoir 10, creating bubbles 24 that move through the fluid. The controller 28 can be programmed through software or hardware to actuate the pump 16 at a certain amplitude or audio frequency. For example, in one preferred embodiment, the controller 28 actuates the pump 16 when a low frequency sound is detected. This may occur at a single frequency, or within a frequency range. The controller 28 can cause the pump 16 to release a longer stream of air upon the reception of low frequency sounds, resulting in longer streams of bubbles 24. By doing so, the bubble display device substantially synchronizes rising bubbles 24 to an audio frequency. The controller 28 can also be programmed to generate a second signal that can drive an internal or external speaker. Should an internal speaker 34 be provided in an embodiment, the device could act as an intercom. The internal speaker 34 could also be of a type that allows the device to be connected to a stereo system to provide surround sound as well as many other types of sound. Speaker jacks could be provided to facilitate simple attachment. The device could also be connected to a radio, a telephone or any other device that receives incoming radio signals and converts them to perceptible forms, such as sound or light. For example, should an embodiment be connected to a telephone, the device could produce sound, light and bubble effects when the telephone receives a call. It is also possible to connect the controller 28 to an illumination source so that the illumination source is regulated by the controller 28 and is substantially synchronized with the sound and bubble effects by varying the light's intensity or color to the amplitude or frequency of the sound.

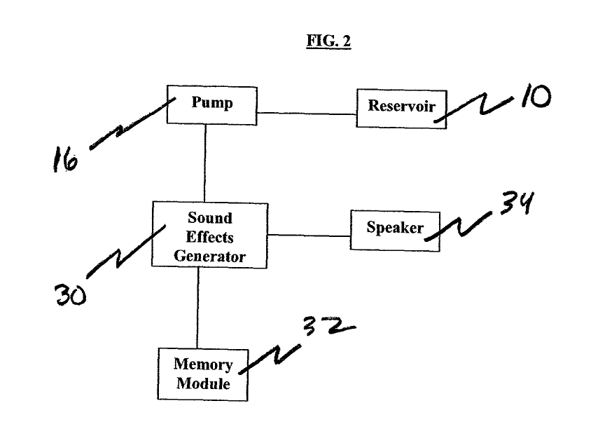

In an alternative preferred embodiment, as shown in FIG. 2, a sound effects generator 30 is capable of producing sounds and controlling the pump 16. In one preferred embodiment, the sound effects generator 30 can play any audio format, such as WAV, MIDI or MP3 files in real or delayed time. In this preferred embodiment, the original sound quality can be maintained because no further analog or digital processing introduces noise or distortion into the stored or synthesized sound. The sound files can be stored in a memory module 32 that can be a unitary part of the sound effects generator 30, or can be stored in removable media such as COMPACTFLASH™ cards, SMART MEDIA™ cards, or MEMORY STICKs™. Other types of non-volatile, volatile or permanent storage may also be utilized. It is also possible for the sound effects generator 30 to receive sounds directly from a computer or other external device.

Preferably, the sound effects generator 30 is operated by a mechanical switch. Alternatively, an audio sensor, a motion sensor, or any other digital or analog control signal can activate the sound effects generator 30. Preferably, the sound effects generator 30 generates a first signal capable of controlling the pump 16 and a second signal that drives a speaker 34. Alternatively, the sound effects generator can include an external amplifier to amplify the audio signals that drive the speaker 34.

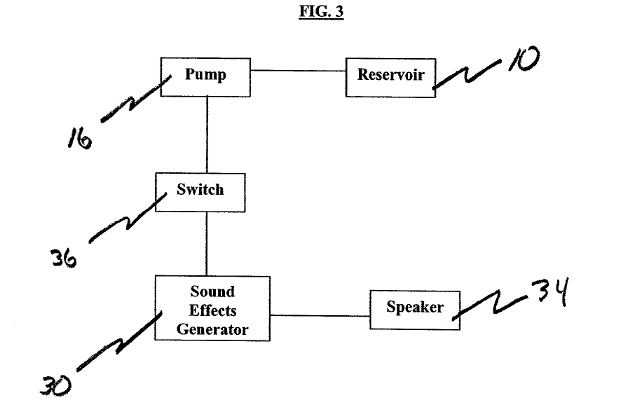

In yet another preferred embodiment, as shown in FIG. 3, the sound effects generator 30 does not directly control the pump 16. Rather, the sound effects generator 30 has a first connection to a switch 36 that controls the pump 16. The sound effects generator 30 also generates a second signal to control the speaker 34. The switch 36 can be an electrical switch such as a relay, a pneumatic switch such as a baffle, or any other audio, motion or light-activated switch. Upon actuation, the switch 36 causes the pump 16 to release air into the reservoir 10 to create the rising bubble effect that is substantially synchronized to the sounds produced by the sound effects generator 30.

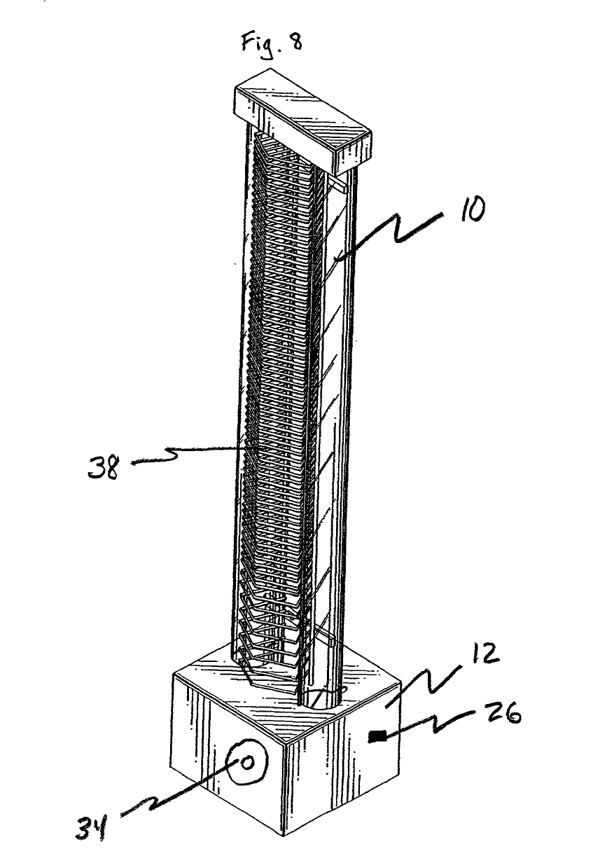

In yet another alternative preferred embodiment, as shown in FIG. 8, a storage rack 38 is integrated as a unitary part of the reservoir 10. As shown in FIG. 8, the reservoir 10 is coupled to the side of the storage rack 28, although it can be attached in any manner or at any location. This preferred embodiment allows the device to be used both for decoration and storage.

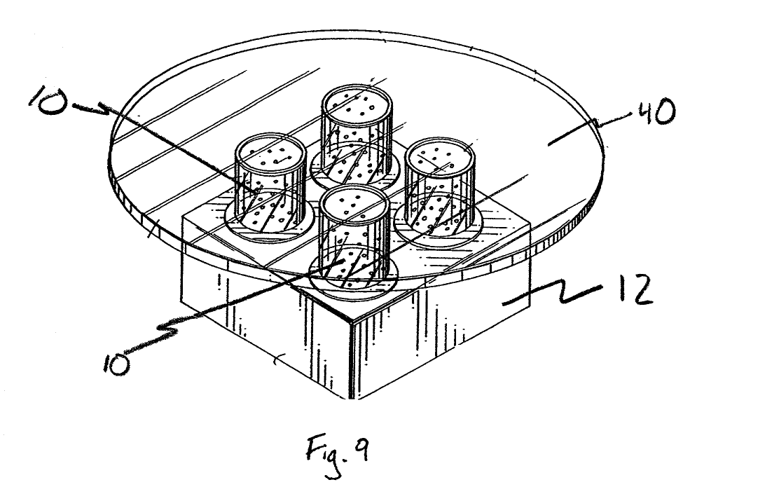

Another alternative preferred embodiment is shown in FIG. 9 coupling a table 40 to multiple cylindrical reservoirs 10. The reservoirs 10 in this embodiment are preferably a unitary part of or attached to a base 12 and are formed from material that can bear weight placed on the table 40. This preferred embodiment could be used in the bar of a restaurant, for example, to alert patrons that their dinner table is ready. In one mode, this embodiment can synchronize bubbles 24 and light to ambient sounds or music, as described above. Upon activation, the device could switch to an alert mode, causing a color change or a different pattern of bubbles 24 to alert the patron. This visual signal could provide notification even in noise-filled areas such as bars and restaurants. An internal speaker 34 could also be coupled to an intercom notification system.

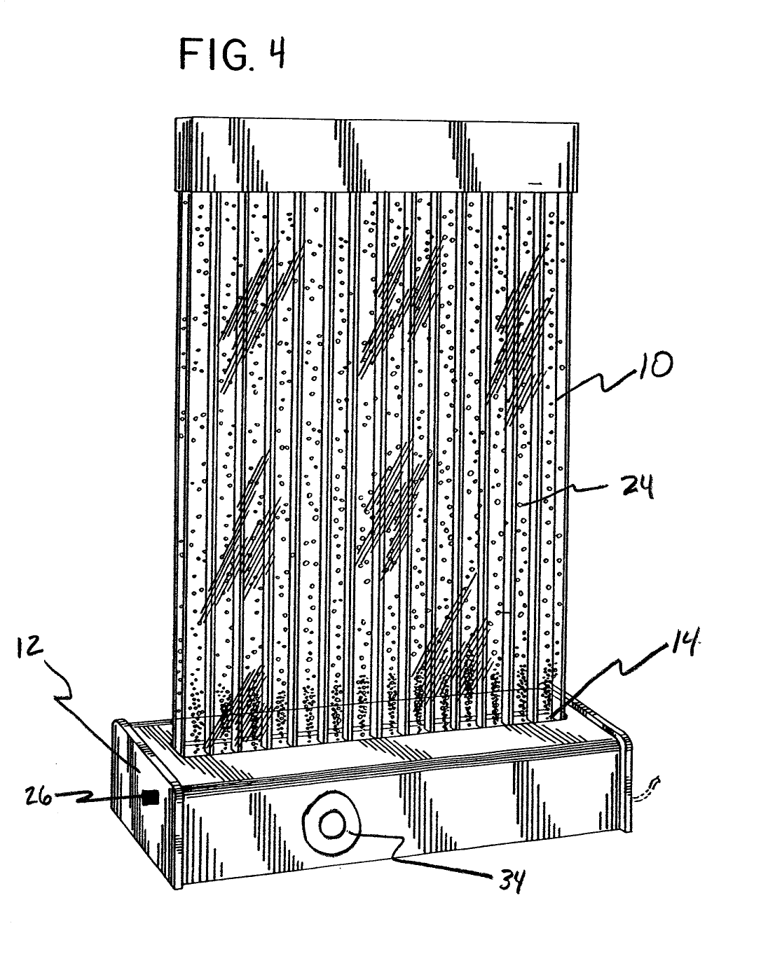

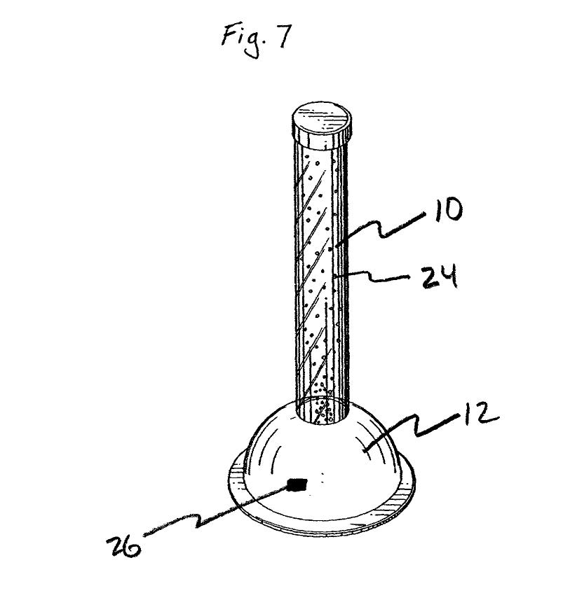

Many other variations can be made to the above-mentioned preferred embodiments without departing from their scope. For example, the preferred embodiments should not be limited to a flat panel reservoir 10 as shown in FIGS. 4-6. Alternatively, the reservoir 10 could be cylindrical shaped, as shown in FIG. 7. The reservoir 10 could also take other forms, such as rectilinear, curvilinear, palm-tree shaped, conical, or a curved table, for example. Furthermore, the pump 16, sound effects generator 30 and speaker 34 can be a unitary part of or be electrically interfaced with any bubble display device. Another alternative embodiment includes the use of interchangeable colored lenses, filters or other colored illumination sources that change the color of the liquid in the reservoir 10. These colored lenses or filters can be manually or automatically changed, or coupled to the sound effects generator 30 and controlled so that the color of the fluid can be changed in sync with the rising bubbles and audio effects. The colored lenses or filters are preferably positioned near the bottom of the reservoir 10 near the illumination source so that rays of colored light pass through the fluid. Preferably, the light is not diffused by bubbles that can accumulate near the upper surface of the reservoir 10 in some preferred embodiments. LEDs that vary in color or have varying colors or shapes can also be used to not only illuminate the reservoir 10, but also to provide decoration on the outside of the reservoir 10 and the base 12. These LEDs can be synchronized to activate upon reception of a certain frequency of sound or other external or internal signal. Other forms of visual illumination could be used as well, such as lasers interacting with mirrors, or filters having designs on them such as fish, that could be projected into the reservoir 10 or onto a nearby wall.

It is also possible to link many preferred embodiments together in a chain such that a signal can activate many devices at one time. These chains can be programmed in any manner, such as activating all the devices at the same time upon reception of a certain signal, or activating each device in sequence.

A preferable pump 16 for use in the present invention is a 12 volt, 60 hertz, SONIC SILENT POWERFUL AIR PUMP™ manufactured by SONIC™, but many different types of pumps can also be used. A preferable sound effects generator 30 for use in the present invention is a TITRON™ sound effects generator 30, but other sound effects generators can also be used. A preferred speaker is a CTX™ speaker, and more than one speaker can be used in the invention.

The foregoing detailed description describes only a few of the many forms that the present invention can take. Thus, it is intended that the foregoing detailed description be regarded as illustrative rather than limiting and that it be understood that it is the following claims, including all equivalents, which are intended to define the scope of the invention.

What is claimed is:

1. A rising bubble display comprising:
a liquid-filled reservoir;
a pump fluidly coupled to said reservoir;
an audio signal input;
a controller coupled to said audio signal input and coupled to said pump wherein upon reception of an audio signal, said controller generates a first signal capable of actuating said pump.

2. The rising bubble display of claim 1, further comprising a speaker coupled to said controller.

3. The rising bubble display of claim 2, wherein said controller generates a second signal capable of driving said speaker.

4. The rising bubble display of claim 3, wherein said audio signal input is a microphone.

5. The rising bubble display of claim 3, wherein said audio signal input can receive signals through a removable connection to an audio device.

6. The rising bubble display of claim 3, wherein upon actuation, said pump generates a stream of bubbles in said reservoir.

7. The rising bubble display of claim 6, wherein said actuation of said pump is substantially synchronized with said audio signals received by said audio signal input.

8. The rising bubble display of claim 7, further comprising an illumination source for illuminating said reservoir.

10. The rising bubble display of claim 9, further comprising a connection between said controller and said illumination source allowing said controller to regulate said illumination source.

11. The rising bubble display of claim 10, wherein said illumination source is substantially synchronized with said audio signals received by said audio signal input.

12. A rising bubble display comprising:
a fluid-filled reservoir;
a pump fluidly coupled to said reservoir; and
a sound effects generator having a first connection to said pump and a second connection to a speaker, said sound effects generator configured so as to generate a first signal capable of actuating said pump and a second signal capable of driving said speaker.

13. The rising bubble display of claim 12, wherein upon actuation, said pump produces a stream of bubbles in said reservoir.

14. The rising bubble display of claim 13, wherein said actuation of said pump is substantially synchronized with sounds produced by said sound effects generator.

15. The rising bubble display of claim 14, further comprising a memory module capable of storing sound files.

16. The rising bubble display of claim 15, wherein said speaker is an internal speaker.

17. The rising bubble display of claim 15, wherein said speaker is an external speaker.

18. A rising bubble display comprising:
a fluid-filled reservoir;
a pump fluidly coupled to said reservoir;
a switch capable of controlling said pump; and
a sound effects generator having a first connection to said switch and a second connection to a speaker, said sound effects generator configured so as to generate a first signal capable of actuating said switch and a second signal capable of driving said speaker.

19. The rising bubble display of claim 18, wherein said switch is an electrical switch.

20. The rising bubble display of claim 18, wherein said switch is a pneumatic switch.
